(19) United States
(12) Patent Application Publication
(10) Pub. No.: US 2026/0196936 A1
(43) Pub. Date: Jul. 9, 2026

(54) DC-DC CONVERTER AND OPERATING METHOD THEREOF

(71) Applicant: SAMSUNG ELECTRONICS CO., LTD., Suwon-si (KR)

(72) Inventors: Youngjin Moon, Suwon-si (KR); Yongseong Roh, Suwon-si (KR); Jingyu Kang, Suwon-si (KR); Hyunwook Yoo, Suwon-si (KR); Eunsang Jang, Suwon-si (KR)

(73) Assignee: SAMSUNG ELECTRONICS CO., LTD., Suwon-si (KR)

(21) Appl. No.: 19/438,077

(22) Filed: Dec. 31, 2025

(30) Foreign Application Priority Data
Jan. 3, 2025 (KR) 10-2025-0001187
Apr. 11, 2025 (KR) 10-2025-0047687

(51) Int. Cl. H02M 3/158; H02M 1/00

(52) U.S. Cl. CPC H02M 3/158; H02M 1/0003

(57) ABSTRACT

A direct current to direct current (DC-DC) converter includes a power conversion circuit including switches that generates an output voltage by adjusting a level of an input voltage based on a switching operation of the switches, and a control circuit that generates a switching signal for controlling the switching operation. The control circuit includes an error amplifier that generates an error voltage, a voltage slew detector that generates a first differential information signal, and a pulse modulation logic that generates a first pulse modulation signal including a first on-time and a first off-time, based on the error voltage, as the switching control signal, and that generates a second pulse modulation signal including a second on-time that is greater than the first on-time, as the switching control signal, and terminates generating the second pulse modulation signal based on a transition of the first differential information signal.

### CROSS-REFERENCE TO RELATED APPLICATIONS

This application is based on and claims priority under 35 U.S.C. § 119 to Korean Patent Application No. 10-2025-0001187, filed on Jan. 3, 2025 and to Korea Patent Application No. 10-2025-0047687, filed on Apr. 11, 2025 in the Korean Intellectual Property Office, the disclosures of each of which being incorporated by reference herein in their entireties.

### BACKGROUND

The present disclosure relates to a direct current to direct current (DC-DC) converter and an operating method thereof.

A power management integrated circuit may generate a supply voltage to provide power to electronic components. The level of the supply voltage may be determined based on the performance of each electronic component. The power management integrated circuit may include a DC-DC converter to generate supply voltages of various levels.

Recently, environments in which load currents change rapidly have been increasing in various electronic systems such as mobile devices, Internet of Things (IoT) devices, and high-performance processors. If the transient response characteristics of a DC-DC converter are not good, excessive fluctuations may occur in the output voltage, which may affect the stability or operational reliability of the system. Therefore, it is advantageous to develop a structure and control method of a DC-DC converter that may maintain a stable output voltage by quickly responding to rapid changes in load current.

### SUMMARY

It is an aspect to provide a direct current to direct current (DC-DC) converter capable of responding quickly to a sudden change in load current and stably generating an output voltage, and an operating method thereof.

According to an aspect of one or more embodiments, there is provided a direct current to direct current (DC-DC) converter comprising a power conversion circuit including a plurality of power switches, the power conversion circuit being configured to generate an output voltage by adjusting a level of an input voltage based on a switching operation of the plurality of power switches; and a control circuit configured to generate a switching control signal for controlling the switching operation of the plurality of power switches. The control circuit comprises an error amplifier configured to generate an error voltage between a first reference voltage and a feedback voltage based on the output voltage; a voltage slew detector configured to generate a differential voltage by differentiating the feedback voltage and to generate a first differential information signal based on the differential voltage; and a pulse modulation logic that is configured to generate a first pulse modulation signal including a first on-time and a first off-time, based on the error voltage, and output the first pulse modulation signal as the switching control signal, and that is configured to generate a second pulse modulation signal including a second on-time that is greater than the first on-time of the first pulse modulation signal, and output the second pulse modulation signal as the switching control signal, and while the second pulse modulation signal is being output as the switching control signal, the pulse modulation logic is further configured to terminate generating the second pulse modulation signal based on a transition from an on level to an off level of the first differential information signal.

According to another aspect of one or more embodiments, there is provided a direct current to direct current (DC-DC) converter comprising a power conversion circuit comprising an inductor, a first power switch, and a second power switch, the power conversion circuit being configured to generate an output voltage by stepping down a level of an input voltage based on a switching operation of the first power switch and the second power switch; and a control circuit configured to control the power conversion circuit to repeat an on state and an off state at a switching frequency based on an error voltage between the output voltage and a reference voltage, and an inductor current flowing through the inductor increasing during the on state and decreasing during the off state, control the power conversion circuit to maintain the on state based on the output voltage decreasing below a threshold voltage, or a rate of change of the output voltage exceeding a threshold value, and control the power conversion circuit to terminate the maintaining of the on state when a derivative of the output voltage is 0.

According to yet another aspect of one or more embodiments, there is provided a method of operating a direct current to direct current (DC-DC) converter comprising a power conversion circuit configured to generate an output voltage from an input voltage based on a switching operation of a plurality of power switches; and a control circuit configured to generate a plurality of switching control voltages provided to the plurality of power switches, the method comprising generating, by the control circuit, a first pulse modulation signal based on an error voltage between a feedback voltage based on the output voltage and a reference voltage; generating, by the control circuit, the plurality of switching control voltages based on the first pulse modulation signal; generating, by the control circuit, a second pulse modulation signal including a second on-time greater than a first on-time of the first pulse modulation signal; generating, by the control circuit, the plurality of switching control voltages based on the second pulse modulation signal; and terminating, by the control circuit, the generating the second pulse modulation signal based on a differential value of the output voltage being 0.

### BRIEF DESCRIPTION OF THE DRAWINGS

Various embodiments will be more clearly understood from the following detailed description taken in conjunction with the accompanying drawings, in which:

FIG. 1 is a block diagram schematically showing a direct current to direct current (DC-DC) converter according to an embodiment;

FIG. 2A and FIG. 2B are graphs showing changes in output voltage according to an increase in load current in a DC-DC converter;

FIG. 3 is a circuit diagram showing a DC-DC converter according to an embodiment;

FIG. 4 is a waveform diagram showing inductor current according to a switching operation of a power conversion circuit;

FIG. 5 is a graph showing changes in inductor current and output voltage according to an increase in load current in a DC-DC converter, according to an embodiment;

FIG. 6 is a graph showing changes in inductor current and output voltage according to an increase in load current in a DC-DC converter, according to a comparative example;

FIG. 7 is a circuit diagram showing pulse modulation logic according to an embodiment;

FIG. 8A and FIG. 8B are timing diagrams of pulse modulation logic according to an embodiment;

FIG. 9 is a circuit diagram showing a control circuit according to an embodiment;

FIG. 10 is a graph showing changes in inductor current and output voltage according to an increase in load current in a DC-DC converter, according to an embodiment;

FIG. 11 is a circuit diagram showing a control circuit according to an embodiment;

FIG. 12A and FIG. 12B are circuit diagrams showing power change circuits of a DC-DC converter, according to some embodiments;

FIG. 13 is a flowchart showing an operating method of a DC-DC converter, according to an embodiment;

FIG. 14 is a block diagram schematically showing an electronic device including a DC-DC converter, according to an embodiment;

FIG. 15 is a block diagram schematically showing an electronic device including a DC-DC converter, according to an embodiment;

FIG. 16 is a block diagram schematically illustrating an electronic device including a DC-DC converter, according to an embodiment; and

FIG. 17 is a block diagram schematically illustrating an electronic device including a DC-DC converter, according to an embodiment.

### DETAILED DESCRIPTION

Reference will now be made in detail to various embodiments, examples of which are illustrated in the accompanying drawings.

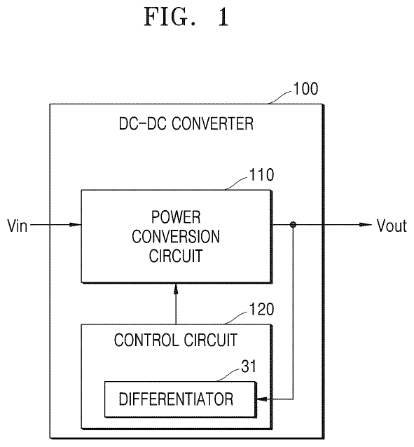

FIG. 1 is a block diagram schematically showing a direct current to direct current (DC-DC) converter 100 according to an embodiment.

The DC-DC converter 100 may be used in portable electronic devices, automotive electrical systems, industrial control devices, etc., and may efficiently convert and supply power according to a voltage level used in each system. For example, the DC-DC converter 100 may be applied to various electronic devices such as smartphones, tablet Personal Computers (PCs), wearable devices, Internet of Things (IoT) devices, drones, electric vehicles, and/or server power supplies. The DC-DC converter 100 may generate an output voltage suitable for each device's components based on an input voltage to the DC-DC converter 100, and may provide the output voltage as a supply voltage to the each device's components. For example, the DC-DC converter 100 may provide a supply voltage to various processors, such as a Central Processing Unit (CPU), a Microprocessor Unit (MPU), a Graphics Processing Unit (GPU) of an Application Processor (AP), memories, communication circuits, etc.

Referring to FIG. 1, the DC-DC converter 100 may include a power conversion circuit 110 and a control circuit 120.

The power conversion circuit 110 (also referred to as a power stage) may convert an input voltage Vin into an output voltage Vout of a desired level (target level). The power conversion circuit 110 may include a plurality of power switches (e.g., transistors) (also referred to as switching elements), and may generate an output voltage Vout by stepping down or stepping up the input voltage Vin according to the operation of the plurality of power switches. The power conversion circuit 110 may generate an output voltage Vout of a desired level based on various control methods.

The control circuit 120 may control the switching operation of the plurality of power switches of the power conversion circuit 110. The control circuit 120 may generate a switching control signal, and may control the switching operation of the plurality of power switches based on the switching control signal.

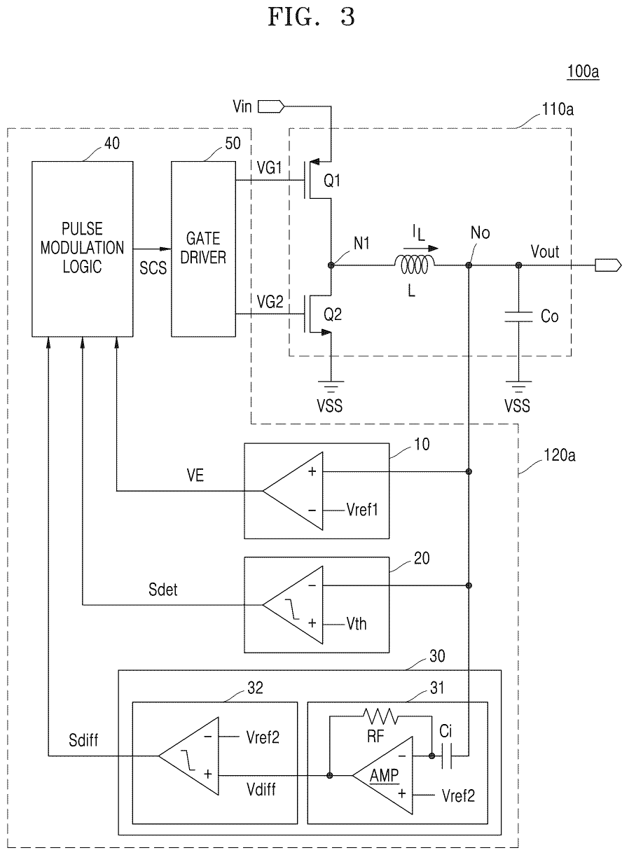

The control circuit 120 may generate a switching control signal according to various control methods, and may change the control method according to a load current. In an embodiment, the control circuit 120 may generate the switching control signal according to a pulse modulation control method during normal operation. For example, the pulse modulation method may include a pulse width modulation (PWM) method or a pulse frequency modulation (PFM) method. The control circuit 120 may generate a first pulse modulation signal including an on-time and an off-time based on an error voltage between the output voltage Vout and a reference voltage, and may generate the switching control signal based on the first pulse modulation signal. Here, during an on-time of the pulse modulation signal, an inductor current flowing through an inductor (e.g., L in FIG. 3 described below) provided in the power conversion circuit 110 may increase, and during an off-time, the inductor current may decrease. During the on-time of the pulse modulation signal, the power conversion circuit 110 may be in an on-state, and during the off-time, the power conversion circuit 110 may be in an off-state.

When the load current increases rapidly, the control circuit 120 may generate the switching control signal according to the on-time extension control method. The control circuit 120 may perform a control operation according to the on-time extension control method (hereinafter, referred to as an on-time extension control operation). If the load current increases rapidly, the inductor current may be less than the load current, and thus the output voltage Vout may be reduced. The control circuit 120 may generate a second pulse modulation signal with an increased on-time according to the on-time extension control method. The on-time of the second pulse modulation signal may be longer than the on-time of the first pulse modulation signal generated according to the pulse modulation control method.

The control circuit 120 may generate the switching control signal based on the second pulse modulation signal. As the on-time of the switching control signal increases, the inductor current may rapidly increase, and as the inductor current increases, the amount of decrease in the output voltage Vout decreases according to the increase in the inductor current, and the output voltage Vout may increase from the point when the inductor current becomes greater than the load current.

The control circuit 120 may include a differentiator 31, and may terminate the on-time extension control operation based on the output value of the differentiator 31. The differentiator 31 may output a differential voltage representing a differential value of the output voltage Vout. The differential value may indicated a rate of change of the output voltage Vout. The control circuit 120 may terminate the control operation according to the on-time extension control method if the differential value of the output voltage Vout is 0. Thereafter, the control circuit 120 may generate the switching control signal according to the pulse modulation control method.

The differential value of the output voltage Vout of zero indicates that the inductor current is equal to the load current. If the on-time extension control method is maintained even after the inductor current increases rapidly and the inductor current becomes equal to the load current, the inductor current may become excessively higher than the load current, and thus, the output voltage Vout may increase excessively. If the control operation according to the on-time extension control method is terminated after the output voltage Vout increases (recovers) to a threshold voltage, the inductor current may increase excessively, and the output voltage Vout may increase excessively or decrease excessively compared to a target level. The threshold voltage may be predetermined.

Therefore, the DC-DC converter 100 according to an embodiment detects a time point when the inductor current becomes equal to the load current based on the differential value of the output voltage Vout, and terminates the control operation according to the on-time extension control method at the time point when the inductor current becomes equal to the load current, thereby preventing the output voltage Vout from increasing or decreasing excessively.

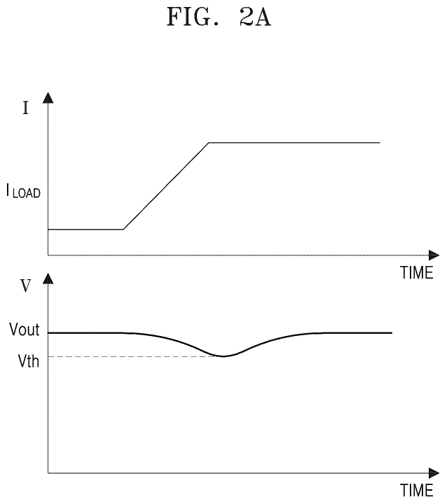

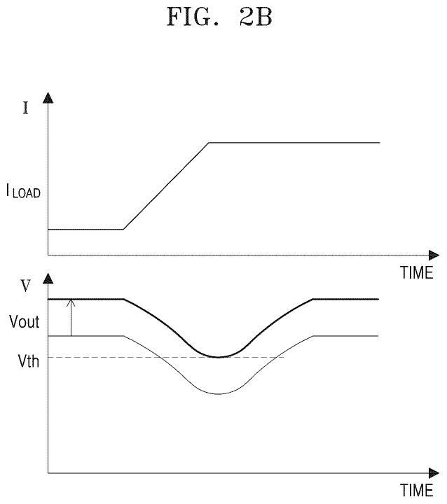

FIGS. 2A and 2B are graphs showing changes in output voltage according to an increase in load current in the DC-DC converter 100.

A DC-DC converter may be used as supply power for a main intellectual property (IP) (e.g., a CPU, a GPU, an NPU, etc.) in a system (e.g., a system-on-chip (SoC)) of an electronic device. A power voltage may be generated based on the output voltage Vout of the DC-DC converter and the power voltage may be provided to one or more IPs. Therefore, the transient response characteristics of the DC-DC converter directly affect the operation and function of the one or more IPs and may cause a malfunction of the one or more IPs.

As shown in FIGS. 2A and 2B, when a load current I_{LOAD} increases rapidly, an undershoot, in which the output voltage Vout becomes lower than a target level, may occur. As shown in FIG. 2A, if the undershoot is small, the output voltage Vout does not fall below a threshold voltage Vth, and the power voltage may be stably supplied to the IPs.

However, as shown in FIG. 2B, if the undershoot is large, the power voltage provided to the IPs at the time of the undershoot occurrence may be lowered, which may cause malfunction of the IPs. If the target level of the output voltage Vout is set higher considering the undershoot, the level of the power supply provided to the IPs increases, and dynamic power consumption proportional to the square of the power voltage increases. The increase in the dynamic power consumption increases the heat generation of the IPs, and therefore, the operating speed of the IPs may not be increased, which results in deterioration of the performance of the system. On the other hand, if the overshoot, in which the output voltage Vout becomes higher than the target level, is large, it may cause malfunctions such as bit-flips.

However, as described above with reference to FIG. 1, the DC-DC converter 100 according to an embodiment may minimize undershoot and overshoot, thereby improving the transient response characteristics and improving the stability of the output voltage Vout. Accordingly, the reliability of the system to which the DC-DC converter 100 supplies power increases, and performance degradation of the system due to response delay may be prevented.

FIG. 3 is a circuit diagram showing a DC-DC converter 100a according to an embodiment. In an embodiment, the DC-DC converter 100a may be a more detailed example of the DC-DC converter 100 in FIG. 1.

Referring to FIG. 3, the DC-DC converter 100a may include a power conversion circuit 110a and a control circuit 120a.

The power conversion circuit 110a may include a plurality of power switches, such as a first switch Q1 and a second switch Q2, an inductor L, and an output capacitor Co. In an embodiment, the power conversion circuit 110a may be implemented as a single phase buck converter as shown in FIG. 3. However, the power conversion circuit 110a is not limited thereto, and the power conversion circuit 110a may be implemented using various types of converters such as a multi-phase buck converter, a boost-buck converter, a buck-boost converter, and a bidirectional buck-boost converter.

In an embodiment, the first switch Q1 and the second switch Q2 may be implemented as transistors. For example, the first switch Q1 may be implemented as a P-type metal oxide semiconductor field effect transistor (MOSFET) (PMOS), and the second switch Q2 may be implemented as an N-type MOSFET (NMOS). However, embodiments are not limited thereto, and in some embodiments, both the first switch Q1 and the second switch Q2 may be implemented as a PMOS or an NMOS, or the first switch Q1 and the second switch Q2 may be implemented as different types of switching elements.

The first switch Q1 and the second switch Q2 may be connected in series, an input voltage Vin may be applied to the first switch Q1, and a ground voltage VSS may be applied to the second switch Q2. The inductor L may be connected to the first switch Q1 and the second switch Q2 at a first node N1, and may be connected to the output capacitor Co at an output node No.

The first switch Q1 and the second switch Q2 may be turned on or off in response to a first switching voltage VG1 and a second switching voltage VG2 provided from the control circuit 120a, respectively. In an embodiment, the first switch Q1 and the second switch Q2 may perform complementary switching operations, and as such the times at which the first switch Q1 and the second switch Q2 are turned on do not overlap.

The first switch Q1 and the second switch Q2 may provide an input voltage Vin or short-circuit to the inductor L through the switching operation and control a flow path of an inductor current I_{L}. The inductor L may store or release energy, and in some cases, may store and release energy at the same time. The output capacitor Co may reduce a voltage ripple of the output voltage Vout that occurs during the switching operation of the first switch Q1 and the second switch Q2 and thus may prevent the output voltage Vout from changing rapidly when a load current fluctuates.

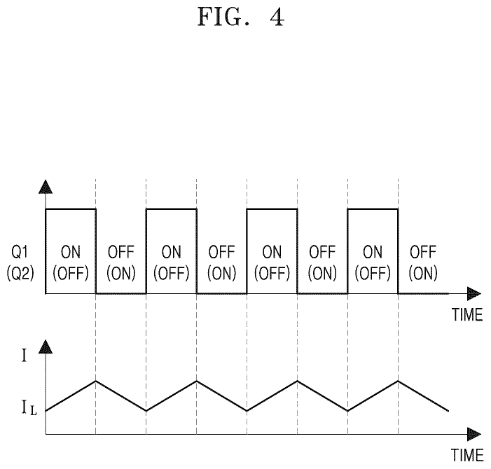

FIG. 4 is a waveform diagram showing an inductor current according to a switching operation of a power conversion circuit, according to an embodiment. For example, FIG. 4 may show the inductor current I_{L} of the inductor L of the power conversion circuit 110a in FIG. 3.

Referring to FIGS. 3 and 4, when the first switch Q1 is turned on, the input voltage Vin is applied to the inductor L and the inductor current I_{L} flowing through the inductor L gradually increases, and accordingly, energy is stored in the inductor L and a current may be supplied to the load at the same time.

When the first switch Q1 is turned off and the second switch Q2 is turned on, the inductor L is disconnected from the input voltage Vin, and the energy stored in the inductor L may be released to the load and the output capacitor Co. During this process, the inductor current I_{L} may gradually decrease.

In the embodiment illustrated in FIGS. 3 and 4, a state in which the inductor current I_{L} increases and energy is stored in the inductor L is referred to as an on state of the power conversion circuit 110a, and a state in which the energy stored in the inductor L is released and the inductor current I_{L} decreases is referred to as an off state. For example, in FIG. 3, the on state of the power conversion circuit 110a may be a state in which the first switch Q1 is turned on, and the off state of the power conversion circuit 110a may be a state in which the first switch Q1 is turned off.

Referring again to FIG. 3, the control circuit 120a may include an error amplifier 10, a threshold voltage detector 20, a voltage slew detector 30, pulse modulation logic 40, and a gate driver 50. The control circuit 120a may further include other configurations such as a compensation circuit, a protection circuit, and/or a current sensing circuit.

The error amplifier 10 may amplify a difference between a first reference voltage Vref1 and the output voltage Vout and output the difference as an error voltage VE. The error amplifier 10 may be implemented as, for example, an operational amplifier, a differential amplifier, or the like. The error voltage VE may be used for switching control of the power conversion circuit 110a to adjust the output voltage Vout to a target level.

The threshold voltage detector 20 may compare the output voltage Vout with a threshold voltage Vth and output a threshold voltage detection signal Sdet. The threshold voltage Vth may be set lower than the target level of the output voltage Vout. The threshold voltage detector 20 may be implemented as a comparator. The threshold voltage detector 20 may output a threshold voltage detection signal Sdet having an off level (e.g., logic low) when the output voltage Vout is higher than the threshold voltage Vth, and may output a threshold voltage detection signal Sdet having an on level (e.g., logic high) when the output voltage Vout is equal to or lower than the threshold voltage Vth. When the load current increases, the output voltage Vout may decrease, and when the output voltage Vout decreases below the threshold voltage Vth, the threshold voltage detector 20 may output a threshold voltage detection signal Sdet having an on level.

The voltage slew detector 30 may generate a differential voltage Vdiff by differentiating the output voltage Vout and may generate a differential information signal Sdiff based on the differential voltage Vdiff. The voltage slew detector 30 may include a differentiator 31 and a comparator 32.

The differentiator 31 may include an amplifier AMP, an input capacitor Ci, and a feedback resistor Rf. The amplifier AMP may include, for example, an operational amplifier, a differential amplifier, etc.

The output voltage Vout is applied to the first input terminal (−) of the amplifier AMP through the input capacitor Ci, and a feedback resistor Rf may be connected between the first input terminal (−) and the output terminal of the amplifier AMP. A second reference voltage Vref2 may be applied to the second input terminal (+) of the amplifier. The second reference voltage Vref2 may be the same as or different from the first reference voltage Vref1. Based on the second reference voltage Vref2, the differentiator 31 may generate a differential voltage Vdiff representing a differential value of the output voltage Vout.

The differential voltage Vdiff may be expressed by Equation 1.

$$Vdiff = Vref 2 - R f \times C i \times \frac{d V o u t ( t )}{d t} \qquad [ Equation 1 ]$$

Here, (dVout (t))/dt is the amount of change in the output voltage Vout per unit time, which represents the differential value of the output voltage Vout. If the differential value of the output voltage Vout is 0, the differential voltage Vdiff may be equal to the second reference voltage Vref2. If the output voltage Vout decreases, the differential voltage Vdiff is greater than the second reference voltage Vref2, and if the output voltage Vout increases, the differential voltage Vdiff is less than the second reference voltage Vref2. The differential value of the output voltage Vout may be 0 at the time point when the inductor current I_{L} becomes equal to the load current, and at this time, the differential voltage Vdiff may be equal to the second reference voltage Vref2.

The differentiator 31 illustrated in FIG. 3 is only an example of the structure of a differentiator according to an embodiment, and the structure of the differentiator is not limited thereto. Differentiators having various circuit structures may be applied to the DC-DC converter 100a according to various embodiments.

The comparator 32 may generate a differentiating information signal Sdiff by comparing the differentiating voltage Vdiff with the second reference voltage Vref2. The comparator 32 may generate a differentiating information signal Sdiff having an on level when the differentiating voltage Vdiff is greater than the second reference voltage Vref2, and may generate a differentiating information signal Sdiff having an off level when the differentiating voltage Vdiff is less than or equal to the second reference voltage Vref2. For example, the comparator 32 may generate a differential information signal Sdiff having an on level when the output voltage Vout decreases, and may generate a differential information signal Sdiff having an off level when the output voltage Vout does not change (the differentiation value is 0) or when the output voltage Vout increases.

The pulse modulation logic 40 may generate a power switching control signal SCS based on the error voltage VE, the threshold voltage detection signal Sdet, and the differential information signal Sdiff. The pulse modulation logic 40 may generate the power switching control signal SCS according to the pulse modulation control method during normal operation. The pulse modulation logic 40 may generate a first pulse modulation signal based on the error voltage VE and may output the first pulse modulation signal as the switching control signal SCS. For example, the first pulse modulation signal may be a PWM signal or a PFM signal. The power conversion circuit 110a may operate in an on-state during the on-time of the switching control signal SCS, and the power conversion circuit 110a may operate in an off-state during the off-time of the switching control signal SCS.

When the load current increases rapidly, the pulse modulation logic 40 may generate the power switching control signal SCS according to an on-time extension control method based on the threshold voltage detection signal Sdet and the differential information signal Sdiff. In an embodiment, the pulse modulation logic 40 may start an on-time extension control based on the threshold voltage detection signal Sdet. For example, when the threshold voltage detection signal Sdet transitions from the off level to the on level, the pulse modulation logic 40 may generate a second pulse modulation signal generated by extending the on-time as the switching control signal SCS. The on-time of the second pulse modulation signal may be greater than the on-time of the first pulse modulation signal. In an embodiment, the second pulse modulation signal may not include an off-time. In some embodiments, the second pulse modulation signal may not include the off-time and may only include the on-time. In an embodiment, the pulse modulation logic 40 may generate the second pulse modulation signal based on the first pulse modulation signal. In an embodiment, the pulse modulation logic 40 may generate the second pulse modulation signal based on a frequency and duty ratio. The frequency and duty ratio may be preset.

The pulse modulation logic 40 may terminate the on-time extension control operation based on the differential information signal Sdiff. The pulse modulation logic 40 may terminate the on-time extension control operation when the differential information signal Sdiff transitions from the on level to the off level. The pulse modulation logic 40 may again generate the power switching control signal SCS according to the pulse modulation control method.

The gate driver 50 may generate the first switching voltage VG1 and the second switching voltage VG2 based on the switching control signal SCS. The gate driver 50 may generate the first switching voltage VG1 and the second switching voltage VG2 having the on level and the off level suitable for turning on and off the first switch Q1 and the second switch Q2, respectively, based on the switching control signal SCS.

In the embodiment illustrated in FIG. 3, the control circuit 120a generates a power switching control signal SCS based on the output voltage Vout. The error amplifier 10, the threshold voltage detector 20, and the voltage slew detector 30 receive the output voltage Vout and operate based on the output voltage Vout. However, embodiments are not limited thereto, and the control circuit 120a may operate based on a feedback voltage that is proportional to the output voltage Vout. In an embodiment, the control circuit 120a may further include a feedback circuit that generates a feedback voltage proportional to the output voltage Vout, and the error amplifier 10, the threshold voltage detector 20, and the voltage slew detector 30 may operate based on the feedback voltage. For example, the feedback circuit may include a voltage divider circuit. The first reference voltage Vref applied to the error amplifier 10 and the threshold voltage Vth applied to the threshold voltage detector 20 may be adjusted according to the ratio of the output voltage Vout and the feedback voltage. In the embodiment illustrated in FIG. 3, when the control circuit 120a and the components included in the control circuit 120a are described as operating based on the output voltage Vout, it may be understood that the operation also includes within its scope an embodiment that operates based on the feedback voltage generated based on the output voltage Vout.

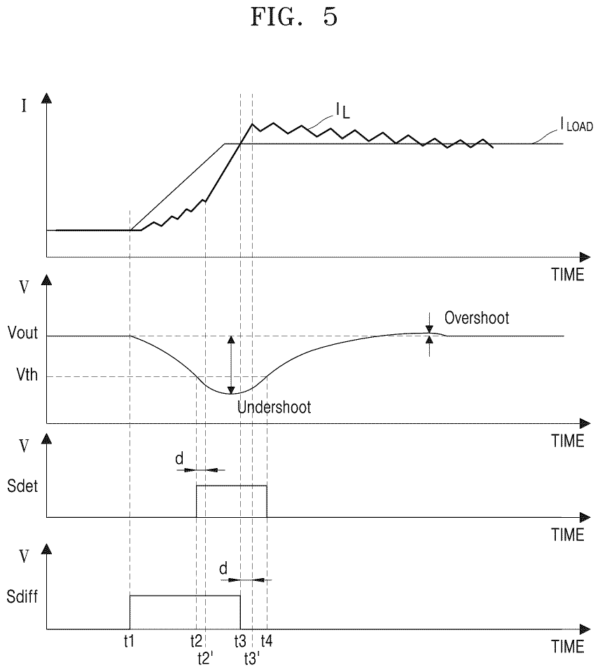

FIG. 5 is a graph showing changes in inductor current and output voltage according to an increase in load current in a DC-DC converter, according to an embodiment.

Referring to FIGS. 3 and 5, at time t1, the load current I_{LOAD} may start increasing, and the output voltage Vout may decrease according to the increase in the load current I_{LOAD}. As the output voltage Vout decreases, the differential information signal Sdiff output from the voltage slew detector 30 may transition from an off level (e.g., logic low) to an on level (e.g., logic high).

The control circuit 120a may generate a power switching control signal SCS according to a PWM method, and the inductor current I_{L} may increase during the on-time of the power switching control signal SCS and decrease during the off-time of the power switching control signal SCS. The rate of increase of the inductor current I_{L} may be slower than the rate of increase of the load current I_{LOAD}. The output voltage Vout may continue to decrease.

When the output voltage Vout decreases to the threshold voltage Vth at time t2, the threshold voltage detection signal Sdet that is output from the threshold voltage detector 20 may transition from the off level to the on level. The control circuit 120a may generate the power switching control signal SCS according to the on-time extension control method as the threshold voltage detection signal Sdet transitions from the off level to the on level.

The on-time of the power switching control signal SCS may increase according to the on-time extension control method. In an embodiment, the power switching control signal SCS may include the on-time and not include an off-time. In the following, in the embodiment illustrated in FIGS. 3 and 5, a case in which the power switching control signal SCS generated according to the on-time extension control method includes the on-time and not the off-time will be described as an example.

From the time point t2′, the power conversion circuit 110a may be controlled according to the on-time extension control method, and the power conversion circuit 110a may continue to maintain the on state. The inductor current I_{L} may increase rapidly. The delay time d denotes a signal transmission delay that may occur due to the physical characteristics of the circuit since the DC-DC converter 100a is implemented as an actual semiconductor integrated circuit.

At time t3, the inductor current I_{L} becomes equal to the load current I_{LOAD}, and the differential value of the output voltage Vout may be 0. Although an undershoot, in which the output voltage Vout becomes less than the target level, occurs due to a rapid increase in the load current I_{LOAD}, the undershoot may be suppressed according to the on-time extension delay method.

At time t3, the differential information signal Sdiff may transition from the on level to the off level. The control circuit 120a may terminate the on-time extension control operation as the differential information signal Sdiff transitions from the off level to the on level, and may generate a power switching control signal SCS according to the pulse modulation control method. From time t3′, the power conversion circuit 110a may be controlled based on the pulse modulation control method, and the power conversion circuit 110a may repeat the on state and the off state. The rapid increase in the inductor current I_{L} ends at time t3′, and thereafter, the inductor current I_{L} may repeat increasing and decreasing within a certain range. Accordingly, the output voltage Vout may gradually increase to the target level.

When the output voltage Vout becomes higher than the threshold voltage Vth at time t4, the threshold voltage detection signal Sdet output from the threshold voltage detector 20 may transition from the on level to the off level. However, the transition from the on level to the off level of the threshold voltage detection signal Sdet at this time does not affect the control method of the control circuit 120a. The control circuit 120a may continuously generate the power switching control signal SCS according to the pulse modulation control method.

The output voltage Vout may reach the target level, and in this process, an overshoot, in which the output voltage Vout becomes higher than the target level, may occur due to the delay time d, but the overshoot caused by the delay time d may not be large.

In this way, according to the control method of the DC-DC converter 100a according to the embodiment, as the inductor current I_{L} quickly follows the load current I_{LOAD}, the transient response characteristic may be improved, and the overshoot and undershoot of the output voltage Vout are suppressed, thereby stably generating the output voltage Vout.

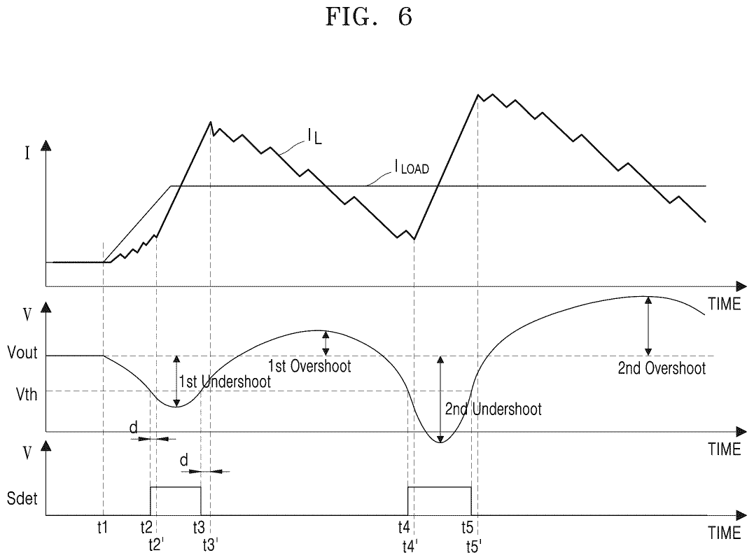

FIG. 6 is a graph showing changes in the inductor current and the output voltage according to an increase in the load current in the DC-DC converter according to a comparative example.

The DC-DC converter according to the comparative example may determine the start and end of the on-time extension control operation based on the threshold voltage Vth.

Referring to FIG. 6, at time t1, as the load current I_{LOAD} increases, the output voltage Vout may decrease. When the output voltage Vout decreases to the threshold voltage Vth at time t2, the threshold voltage detection signal Sdet may transition from the off level to the on level. As the threshold voltage detection signal Sdet transitions from the off level to the on level, the control circuit of the DC-DC converter according to the comparative example may generate a switching control signal based on the on-time extension control method. From time t2′, the power conversion circuit of the DC-DC converter according to the comparative example may be controlled according to the on-time extension control method, and the inductor current I_{L} may rapidly increase.

When the output voltage Vout becomes higher than the threshold voltage Vth at time t3, the threshold voltage detection signal Sdet may transition from the on level to the off level. As the threshold voltage detection signal Sdet transitions from the on level to the off level, the control circuit of the DC-DC converter according to the comparative example may terminate the on-time extension control operation and generate a power switching control signal based on the pulse modulation control method. From the time point t3′, the power conversion circuit of the DC-DC converter according to the comparative example may be controlled according to the pulse modulation control method, and the on state and the off state may be repeated. The rapid increase in the inductor current I_{L} ends at a time point t3′, and thereafter, the inductor current I_{L} may repeat the increase and decrease. However, the inductor current I_{L} increases excessively compared to the load current I_{LOAD}, and the excessive increase of the inductor current I_{L} may cause a first overshoot (1^{st} Overshoot) in the output voltage. Because an overshoot occurs, the off-time of the switching control signal generated based on the error voltage according to the pulse modulation control method increases, and the output voltage Vout may drop rapidly.

The increase in the off-time may cause a second undershoot (2^{nd} Undershoot). As shown, the second undershoot may be greater than a first undershoot (1^{st} Undershoot). This greater second undershoot is because the difference between the load current I_{LOAD} and the inductor current I_{L} is greater than when the first undershoot occurs, and the output voltage Vout drops at a faster slew.

The threshold voltage detection signal Sdet may have an on level during the period when the output voltage Vout is less than the threshold voltage Vth (for example, from time t4 to time t5). From time t4′ to time t5′, the power conversion circuit of the DC-DC converter according to the comparative example may be controlled according to the on-time extension control method, and the inductor current I_{L} may increase rapidly. As the inductor current I_{L} excessively increases compared to the load current I_{LOAD}, a second overshoot (2^{nd} Overshoot) may be induced in the output voltage Vout.

In this way, according to the control method for the DC-DC converter according to the comparative example, as the inductor current I_{L} does not quickly follow the load current I_{LOAD}, repeated undershoots and overshoots may occur in the output voltage Vout.

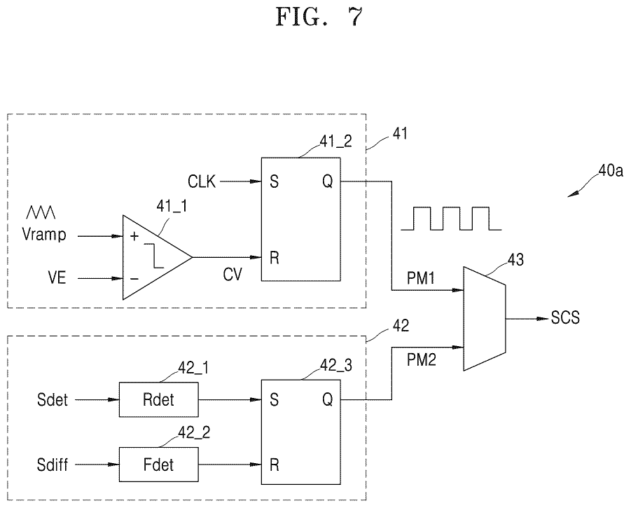

FIG. 7 is a circuit diagram showing a pulse modulation logic 40a according to an embodiment.

Referring to FIG. 7, the pulse modulation logic 40a may include a first pulse modulation signal generator 41, a second pulse modulation signal generator 42, and a multiplexer 43.

The first pulse modulation signal generator 41 may include a comparator 41_1 and an SR latch 41_2. The comparator 41_1 may output a control signal CV by comparing a ramp signal Vramp with the error voltage VE. If the ramp signal Vramp is greater than the error voltage VE, a control signal CV of an on-level (e.g., high-level) may be output, and if the ramp signal Vramp is less than the error voltage VE), a control signal CV of an off-level (e.g., low-level) may be output. The SR latch 41_2 may receive a clock signal CLK through a set input terminal S and a control signal CV through a reset input terminal R. The SR latch 41_2 may be in a set state when the clock signal CLK is at a high level and may output a high-level signal through the output terminal Q, and may be in a reset state when the control signal SV is at a high level and may output a low-level signal through the output terminal Q. Accordingly, a first pulse modulation signal PM1 that repeats an on level (on-time) and an off level (off-time) at a switching frequency (e.g., a frequency of a clock signal (CLK)) may be generated. Here, a duty ratio may be set based on the error voltage VE. The error voltage VE controls the holding time or occurrence time of the control signal CV to adjust the reset time of the SR latch 41_2, and accordingly, the ratio of the on-time and off-time of the first pulse modulation signal PM1 may be determined.

The second pulse modulation signal generator 42 may include a rising edge detector 42_1 (Rdet), a falling edge detector 42_2 (Fdet), and an SR latch 42_3. The rising edge detector 42_1 may detect a rising edge of the threshold voltage detection signal Sdet and output a high-level signal. The falling edge detector 42_2 may detect a falling edge of the differential information signal Sdiff and output a high-level signal. The SR latch 42_3 may receive the output of the rising edge detector 42_1 through the set input terminal S and the output of the falling edge detector 42_2 through the reset input terminal R. The SR latch 42_3 may be set in response to the rising edge of the threshold voltage detection signal Sdet and output a high-level signal through the output terminal Q. Thereafter, the SR latch 42_3 may be reset in response to the falling edge of the differential information signal Sdiff and output a low-level signal through the output terminal Q. Accordingly, the second pulse modulation signal PM2 may be generated.

The multiplexer 43 may output one of the first pulse modulation signal PM1 and the second pulse modulation signal PM2. The pulse modulation logic 40a may output the first pulse modulation signal PM1 as the power switching control signal SCS when performing a control operation according to a pulse modulation control method and may output the second pulse modulation signal PM2 as the power switching control signal SCS when performing a control operation according to an on-time extension control method.

The pulse modulation logic 40a of FIG. 7 is only one implementation example of the pulse modulation logic 40a that may be applied to the DC-DC converter 100 (refer to FIG. 1), but embodiments are not limited thereto. The pulse modulation logic 40a may be modified in various ways. For example, the second pulse modulation signal generator 42 may be implemented as an AND gate, and the multiplexer 430 may be replaced with an OR gate.

The AND gate may output a high-level signal when the threshold voltage detection signal Sdet and the differential information signal Sdiff are on levels (e.g., high levels), and the multiplexer 43 may output the first pulse modulation signal PM1 when the output of the AND gate is low level, and may output a high-level signal when the output of the AND gate is high level. In some embodiments, the pulse modulation logic 40a may be implemented having various circuit structures.

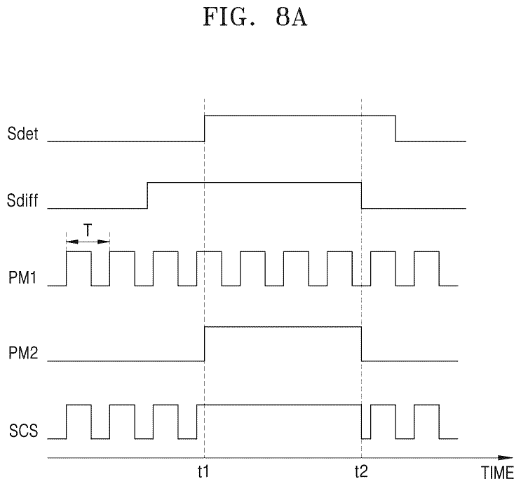

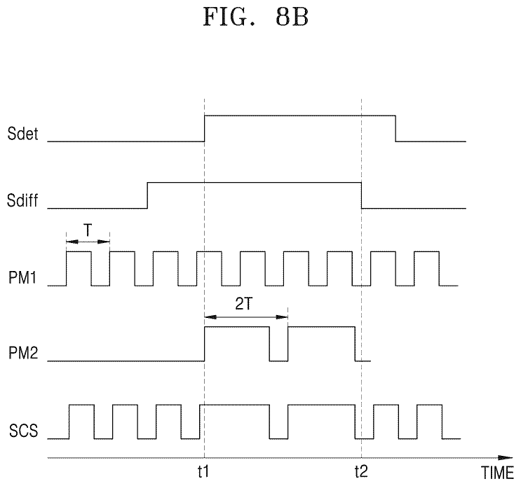

FIG. 8A and FIG. 8B are timing diagrams of pulse modulation logics, according to some embodiments.

Referring to FIG. 8A, a first pulse modulation signal PM1 having a period T may be generated and output as the switching control signal SCS. The period T may be predetermined. When both the threshold voltage detection signal Sdet and the differential information signal Sdiff are at a high level (e.g., from time t1 to time t2) or from the time t1 when the rising edge of the threshold voltage detection signal Sdet occurs to the time t2 when the falling edge of the differential information signal Sdiff occurs, a second pulse modulation signal PM2 at a high level may be generated. The second pulse modulation signal PM2 may be output as the switching control signal SCS.

Referring to FIG. 8B, the second pulse modulation signal PM2 may include an on-time and an off-time, and the on-time of the second pulse modulation signal PM2 may be greater than the on-time of the first pulse modulation signal PM1. For example, the period of the second pulse modulation signal PM2 may be twice the period T of the first pulse modulation signal PM1, and the off-time of the second pulse modulation signal PM2 may be the same as the off-time of the first pulse modulation signal PM1. Accordingly, the on-time of the second pulse modulation signal PM2 may be greater than the on-time of the first pulse modulation signal PM1.

In an embodiment, the period, on-time, and off-time of the second pulse modulation signal PM2 may be preset. In an embodiment, the second pulse modulation signal PM2 may be generated based on the first pulse modulation signal PM1 as the on-time of the first pulse modulation signal PM1 is extended.

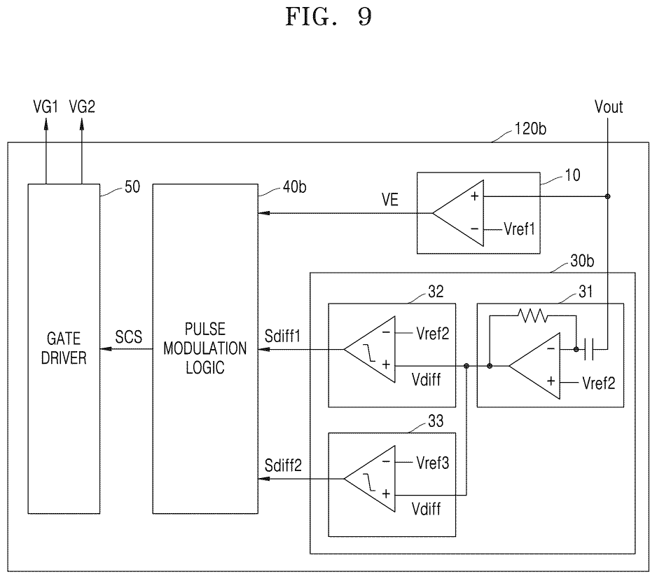

FIG. 9 is a circuit diagram showing a control circuit 120b according to an embodiment. The control circuit 120b may be a more detailed example of the control circuit 120 in FIG. 1.

Referring to FIG. 9, the control circuit 120b may include the error amplifier 10, a voltage slew detector 30b, a pulse modulation logic 40b, and the gate driver 50.

The error amplifier 10 and the gate driver 50 are respectively the same as the error amplifier 10 and the gate driver 50 of FIG. 3. Therefore, repeated descriptions thereof are omitted for conciseness.

The voltage slew detector 30a may generate a differential voltage Vdiff by differentiating an output voltage Vout, and may generate a first differential information signal Sdiff1 and a second differential information signal Sdiff2 based on the differential voltage Vdiff. The voltage slew detector 30a may include a differentiator 31, a first comparator 32, and a second comparator 33.

The differentiator 31 may generate a differential voltage Vdiff representing a differential value of an output voltage Vout, and may output the differential voltage Vdiff to the first comparator 32 and the second comparator 33.

The first comparator 32 may compare the differential voltage Vdiff with a second reference voltage Vref2 to generate a first differential information signal Sdiff1. The operation of the first comparator 32 is the same as the operation of the comparator 32 of FIG. 3, and the first differential information signal Sdiff1 is the same as the differential information signal Sdiff output from the comparator 32 of FIG. 3. The first comparator 32 may generate the first differential information signal Sdiff1 having an off level when the output voltage Vout does not change (differentiation value is 0) or when the output voltage Vout increases.

The second comparator 33 may generate the second differential information signal Sdiff2 by comparing the differential voltage Vdiff with a third reference voltage Vref3. The third reference voltage Vref3 may be greater than the second reference voltage Vref2. The second comparator 33 may generate the second differential information signal Sdiff2 having an on level when the differential voltage Vdiff is greater than the third reference voltage Vref3, and may generate a differential information signal Sdiff having an off level when the differential voltage Vdiff is less than or equal to the third reference voltage Vref3. For example, the second comparator 33 may generate a second differential information signal Sdiff2 having an on level if the decrease in the output voltage Vout is greater than a threshold value, and may generate a second differential information signal Sdiff2 having an off level if the decrease in the output voltage Vout is less than or equal to the threshold value, the output voltage Vout does not change (differentiation value is 0), or the output voltage Vout increases. The threshold voltage may be predetermined.

The pulse modulation logic 40b may generate a power switching control signal SCS based on the error voltage VE, the first differential information signal Sdiff1, and the second differential information signal Sdiff2. The operation of the pulse modulation logic 40b is similar to the operation of the pulse modulation logic 40 of FIG. 3. However, when the load current increases, the pulse modulation logic 40b may start the on-time extension control operation based on the second differential information signal Sdiff2. For example, the pulse modulation logic 40b may generate a second pulse modulation signal having an on-time increased from the on-time of the first pulse modulation signal generated according to the pulse modulation control method as the power switching control signal SCS when the second differential information signal Sdiff2 transitions from the off level to the on level.

The pulse modulation logic 40b may terminate the on-time extension control operation based on the first differential information signal Sdiff1. The pulse modulation logic 40b may terminate the on-time extension control operation when the first differential information signal Sdiff1 transitions from the on level to the off level. The pulse modulation logic 40b may generate the power switching control signal SCS according to the pulse modulation method.

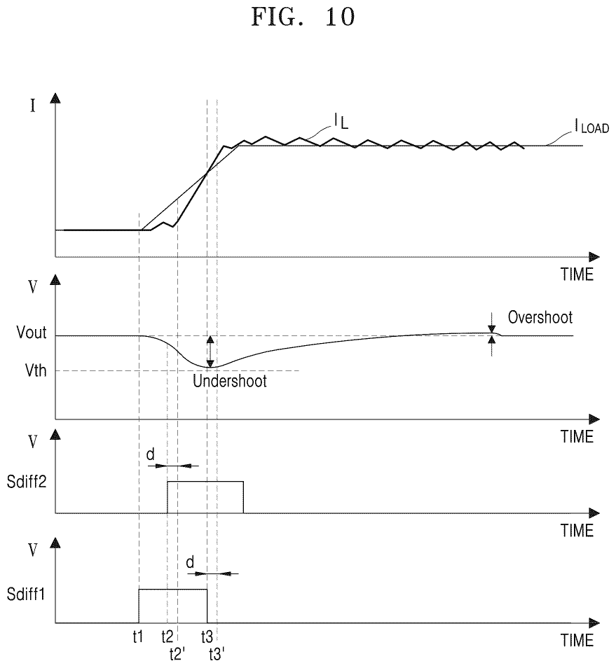

FIG. 10 is a graph showing changes in inductor current and output voltage according to an increase in load current in a DC-DC converter, according to an embodiment.

FIG. 10 shows changes in inductor current and output voltage according to an increase in load current in an embodiment in which the control circuit 120b of FIG. 9 is applied to the DC-DC converter 100 of FIG. 1.

Referring to FIG. 10, at time t1, the load current I_{LOAD} may increase and the output voltage Vout may decrease. As the output voltage Vout decreases, the first differential information signal Sdiff1 output from the voltage slew detector 30b may transition from an off level to an on level.

At time t2, the amount of decrease in the output voltage Vout may be greater than a threshold value, and as the amount of decrease in the output voltage Vout is greater than the threshold value, the second differential information signal Sdiff2 output from the voltage slew detector 30b may transition from the off level to the on level.

The control circuit 120b may generate the power switching control signal SCS according to the on-time extension control method as the second differential information signal Sdiff2 transitions from the off level to the on level. After the delay time d, from time t2′, the power conversion circuit (e.g., 110 of FIG. 1, 110a of FIG. 3) may be controlled according to the on-time extension control method, and the power conversion circuit may continue to maintain the on state. Accordingly, the inductor current I_{L} may increase rapidly.

At time t3, the inductor current I_{L} becomes equal to the load current I_{LOAD}, and the differential value of the output voltage Vout may be 0. At time t3, the first differential information signal Sdiff1 may transition from the on level to the off level. The control circuit 120b may terminate the on-time extension control operation as the first differential information signal Sdiff1 transitions from the off level to the on level, and generate the power switching control signal SCS according to the pulse modulation control method. From time t3′, the power conversion circuit may be controlled according to the pulse modulation method.

According to an embodiment, even if the output voltage Vout does not fall to the threshold voltage Vth, the control circuit 120b may start the on-time extension control operation when the amount of decrease of the output voltage Vout becomes greater than the threshold value. The undershoot of the output voltage Vout may be reduced as the on-time extension control operation starts quickly before the output voltage Vout drops to the threshold voltage Vth.

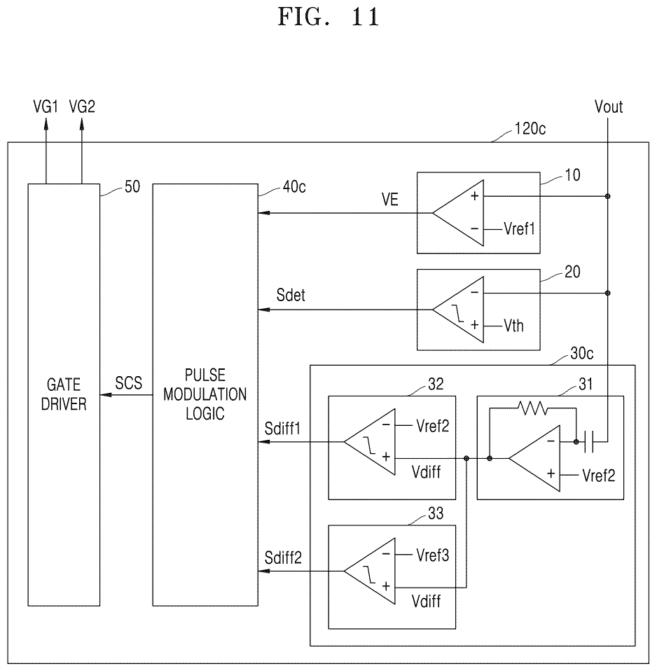

FIG. 11 is a circuit diagram showing a control circuit 120c according to an embodiment. The control circuit 120c may be a more detailed example of the control circuit 120 of FIG. 1.

Referring to FIG. 11, the control circuit 120c may include the error amplifier 10, the threshold voltage detector 20, a voltage slew detector 30c, a pulse modulation logic 40c, and the gate driver 50.

The error amplifier 10, the threshold voltage detector 20, and the gate driver 50 may be respectively identical to the error amplifier 10, the threshold voltage detector 20, and the gate driver 50 of FIG. 3, and the voltage slew detector 30c may be identical to the voltage slew detector 30c of FIG. 8, and accordingly repeated description thereof is omitted for conciseness.

The pulse modulation logic 40c may generate a power switching control signal SCS based on the error voltage VE, the threshold voltage detection signal Sdet, the first differential information signal Sdiff1, and the second differential information signal Sdiff2. The pulse modulation logic 40c may generate a first pulse modulation signal based on the error voltage VE according to the pulse modulation method and output the first pulse modulation signal as the switching control signal SCS.

The pulse modulation logic 40c may start an on-time extension control operation based on the threshold voltage detection signal Sdet or the second differential information signal Sdiff2. As the load current increases and the output voltage Vout decreases, the threshold voltage detection signal Sdet may transition from the off level to the on level, and also the second differential information signal Sdiff2 may transition from the off level to the on level. At this time, depending on the rate of decrease of the output voltage Vout, the point in time at which the threshold voltage detection signal Sdet transitions from the off level to the on level may be earlier than the point in time at which the second differential information signal Sdiff2 transitions from the off level to the on level, or the point in time at which the second differential information signal Sdiff2 transitions from the off level to the on level may be earlier than the point in time at which the threshold voltage detection signal Sdet transitions from the off level to the on level.

The pulse modulation logic 40c may start the on-time extension control operation from the earlier point in time between the point in time at which the threshold voltage detection signal Sdet transitions from the off level to the on level and the point in time at which the second differential information signal Sdiff2 transitions from the off level to the on level.

For example, if the point in time at which the threshold voltage detection signal Sdet transitions from the off level to the on level is earlier than the point in time at which the second differential information signal Sdiff2 transitions from the off level to the on level, the pulse modulation logic 40c may start the on-time extension control operation when the threshold voltage detection signal Sdet transitions from the off level to the on level. At this time, the second differential information signal Sdiff2 may have an off level.

If the point in time at which the second differential information signal Sdiff2 transitions from the off level to the on level is earlier than the point in time at which the threshold voltage detection signal Sdet transitions from the off level to the on level, the pulse modulation logic 40c may start the on-time extension control operation when the second differential information signal Sdiff2 transitions from the off level to the on level. At this time, the threshold voltage detection signal Sdet may have an off level.

Thereafter, the pulse modulation logic 40c may terminate the on-time extension control operation when the first differential information signal Sdiff1 transitions from the on level to the off level.

According to an embodiment, the control circuit 120c may start the on-time extension control operation when the output voltage Vout falls to the threshold voltage Vth or when the amount of decrease in the output voltage Vout becomes greater than the threshold value. The control circuit 120c may start the on-time extension control operation based on the threshold voltage Vth when the output voltage Vout falls gradually, and may start the on-time extension control operation based on the amount of decrease in the output voltage Vout when the output voltage Vout falls rapidly. In this way, the control circuit 120c according to the embodiment illustrated in FIG. 11 may quickly start the on-time extension control operation adaptively according to the falling speed of the output voltage Vout, and thus, the undershoot of the output voltage Vout may be reduced.

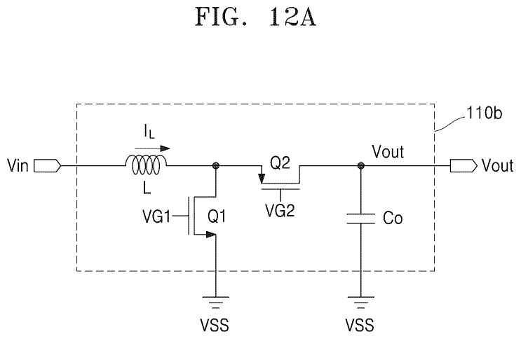

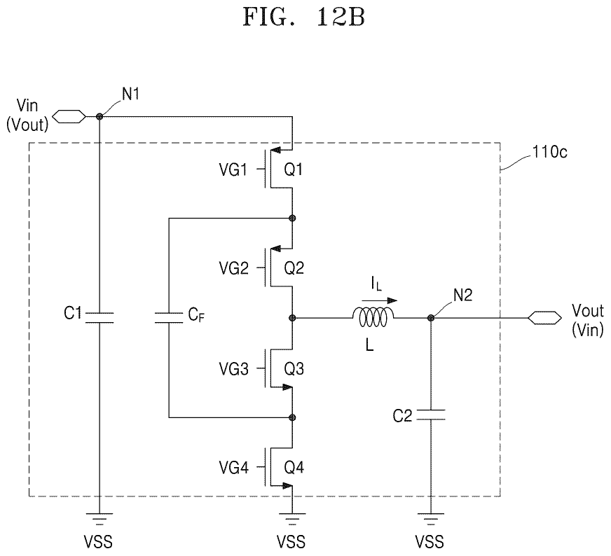

FIGS. 12A and 12B are circuit diagrams showing a power change circuit of a DC-DC converter, according to some embodiments.

Referring to FIG. 12A, a power conversion circuit 110b may include a plurality of power switches, for example, a first switch Q1 and a second switch Q2, an inductor L, and an output capacitor Co, and may be implemented as a boost converter. The first switch Q1 and the second switch Q2 may operate complementarily.

When an input voltage Vin is applied to the inductor L and the first switch Q1 is turned on, an inductor current I_{L} increases linearly, and energy may be stored in the inductor L. At this time, because the second switch Q2 is turned off, energy is not supplied to the load.

When the first switch Q1 is turned off and the second switch Q2 is turned on, the energy stored in the inductor L is released, and a current may be supplied to the load. The inductor current I_{L} decreases linearly, and the output voltage Vout may increase.

In FIG. 12A, the on state of the power conversion circuit 110b may be a state in which the first switch Q1 is turned on, and the off state of the power conversion circuit 110b may be a state in which the first switch Q1 is turned off. When the power conversion circuit 110b is controlled according to the on-time extension control method, the on state of the power conversion circuit 110b, for example, the turn-on time of the first switch Q1, may be increased compared to the turn-on time of the first switch Q1 when the power conversion circuit 110b is controlled according to the pulse modulation method.

Referring to FIG. 12B, a power conversion circuit 110c may include a plurality of power switches, for example, a first switch Q1, a second switch Q2, a third switch Q3, and a fourth switch Q4, an inductor L, a flying capacitor CF, a first capacitor C1, and a second capacitor C2, and may be implemented as a bidirectional 3-level buck-boost converter. The first capacitor C1 and the second capacitor C2 are used for the stabilization of the input voltage Vin and the output voltage Vout, and the flying capacitor CF may provide an intermediate voltage of the input voltage Vin to the inductor L.

The power conversion circuit 110c may operate as a buck converter that steps down an input voltage Vin input through the first node N1 and generates an output voltage Vout output through the second node N2.

When the power conversion circuit 110c operates as a buck converter, the first switch Q1 and the third switch Q3 are turned on and the second switch Q2 and the fourth switch Q4 are turned off, the inductor current I_{L} may gradually increase, and accordingly, energy is stored in the inductor L, and at the same time, current may be supplied to the load.

When the first switch Q1 and the third switch Q3 are turned off and the second switch Q2 and the fourth switch Q4 are turned on, the energy stored in the inductor L is released to the load and the output second capacitor C2, and the inductor current I_{L} may gradually decrease.

The on state of the power conversion circuit 110c may be a state in which the first switch Q1 and the third switch Q3 are turned on, and the off state of the power conversion circuit 110c may be a state in which the first switch Q1 and the third switch Q3 are turned off.

The power conversion circuit 110c may operate as a boost converter that boosts the input voltage Vin input through the second node N2 and generates the output voltage Vout output through the first node N1.

When the power conversion circuit 110c operates as a boost converter, the second switch Q2 and the fourth switch Q4 are turned on, and the first switch Q1 and the third switch Q3 are turned on, a reverse inductor current I_{L} gradually increases, and thus, energy may be stored in the inductor L. Thereafter, when the second switch Q2 and the fourth switch Q4 are turned off, and the first switch Q1 and the third switch Q3 are turned on, the energy stored in the inductor L is released to the load and the first capacitor C1, and the reverse inductor current I_{L} may gradually decrease.

The on state of the power conversion circuit 110c may be a state in which the second switch Q2 and the fourth switch Q4 are turned on, and the off state of the power conversion circuit 110c may be a state in which the second switch Q2 and the fourth switch Q4 are turned off.

In this way, the power conversion circuit 110 of the DC-DC converter 100 (refer to FIG. 1) according to the embodiment may be implemented as a converter having various structures.

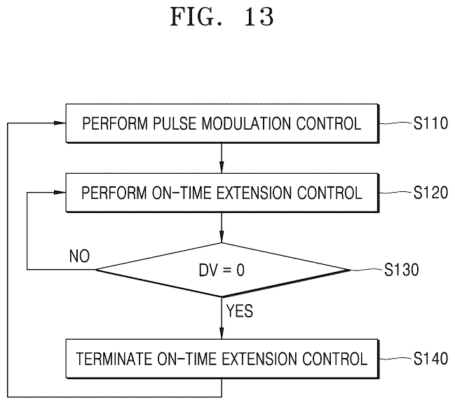

FIG. 13 is a flowchart showing a method of operating the DC-DC converter 100 according to an embodiment.

The method of FIG. 13 may be performed in the control circuit 120 of the DC-DC converter 100 of FIG. 1.

Referring to FIG. 13, the control circuit 120 may perform a pulse modulation control (S110). For example, the control circuit 120 may perform a control operation based on a pulse modulation control method (hereinafter referred to as a pulse modulation control operation). The control circuit 120 may control a switching operation of the power conversion circuit 110 based on the pulse modulation control method. The control circuit 120 may generate a switching control signal that controls the switching operation of the power conversion circuit 110 based on an error voltage.

The control circuit 120 may perform an on-time extension control (S120). For example, the control circuit 120 may perform an on-time extension control operation. The control circuit 120 may perform the on-time extension control operation when an output voltage of the power conversion circuit 110 drops below a threshold voltage or an amount of decrease in the output voltage becomes greater than a threshold value TH as a load current increases rapidly. The control circuit 120 may extend the on-time of the switching control signal or generate a switching control signal including the on-time and excluding an off-time.

The control circuit 120 may determine whether a differential value DV of the output voltage is 0 (S130). For example, the control circuit 120 may determine whether the differential value DV of the output voltage is 0 based on a differential information signal. If the differential value DV of the output voltage is 0 (S130, YES), a differential information signal having an off level may be generated, and if the differential value DV of the output voltage is not 0 (S130, NO), a differential information signal having an on level may be generated.

If the differential information signal is at the on level, that is, if the differential value DV of the output voltage is not 0 (S130, NO), the control circuit 120 may continue to perform the on-time extension control operation (S120).

The control circuit 120 may terminate the on-time extension control (S140). For example, the control circuit 120 may terminate the on-time extension control operation when the differential information signal transitions from the on level to the off level, that is, when the differential value DV of the output voltage Vout becomes 0 (S130, YES). The control circuit 120 may control the switching operation of the power conversion circuit 110 based on the pulse modulation control method.

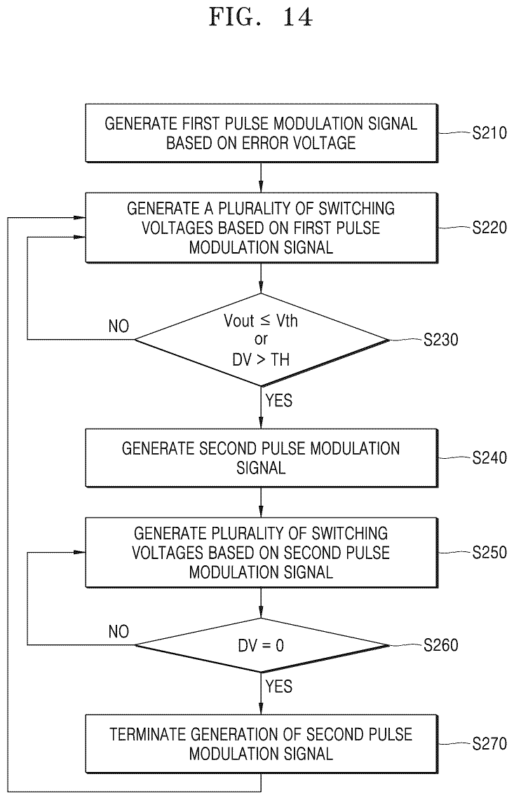

FIG. 14 is a flowchart showing a method of operating the DC-DC converter 100 according to an embodiment.

The method of FIG. 14 may be performed in the control circuit 120 of the DC-DC converter 100 of FIG. 1.

Referring to FIG. 14, the control circuit 120 may generate a first pulse modulation signal based on an error voltage (S210). For example, the control circuit 120 may generate the first pulse modulation signal based on the error voltage between the output voltage and the reference voltage based on the pulse modulation control method. The first pulse modulation signal may include an on-time and an off-time.

The control circuit 120 may generate a plurality of switching voltages based on the first pulse modulation signal (S220). The plurality of switching voltages may be applied to each of the plurality of power switches of the power conversion circuit 110 to control the switching operation. According to operations S210 and S220, the control circuit 120 may perform the pulse modulation control operation.

The control circuit 120 may determine whether the output voltage Vout is less than or equal to a threshold voltage Vth or whether a differential value DV of the output voltage Vout is greater than the threshold value TH (S230). For example, the threshold voltage detector (e.g., 20 of FIG. 3) may output an on-level threshold voltage detection signal if the output voltage Vout is lower than or equal to the threshold voltage Vth. For example, a voltage slew detector (e.g., 30b of FIG. 9) may output an on-level second differential information signal Sdiff2 if the differential value DV of the output voltage Vout is greater than the threshold value TH.

When the output voltage Vout is greater than the threshold voltage Vth and the differential value DV is less than or equal to the threshold value TH (S230, NO), the control circuit 120 may continuously generate a plurality of switching voltages based on the first pulse modulation signal (S220).

When the output voltage Vout is less than or equal to the threshold voltage Vth or the differential value DV is greater than the threshold value TH (S230, YES), the control circuit 120 may generate a second pulse modulation signal (S240). For example, the control circuit 120 may generate the second pulse modulation signal in which on-time is increased compared to the on-time of the first pulse modulation signal based on the on-time extension control method. In an embodiment, the second pulse modulation signal may include the on-time and may not include the off-time.

The control circuit 120 may generate a plurality of switching voltages based on the second pulse modulation signal (S250). According to operations S240 and S250, the control circuit 120 may perform the on-time extension control operation.

The control circuit 120 may determine whether the differential value DV of the output voltage Vout is 0 (S260), and if the differential value DV is not 0 (S260, NO), may continuously generate a plurality of switching voltages based on the second pulse modulation signal (S250). When the differential value DV of the output voltage Vout becomes 0 (S260, YES), the control circuit 120 may terminate the generation of the second pulse modulation signal (S270). The control circuit 120 may terminate the on-time extension control operation. The control circuit 120 may control the switching operation of the power conversion circuit 110 based on the pulse modulation control method.

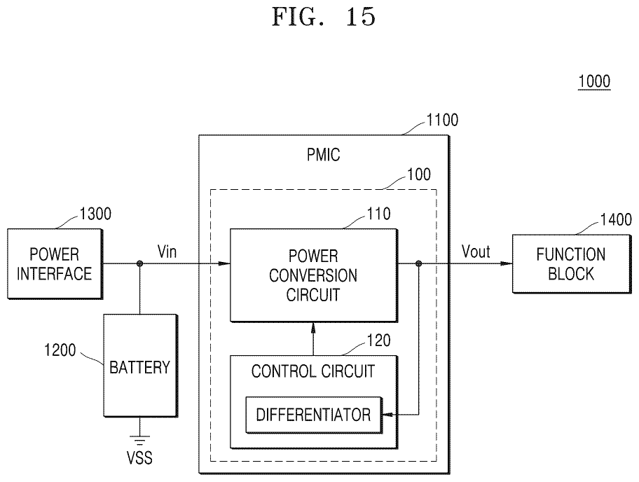

FIG. 15 is a block diagram schematically illustrating an electronic device 1000 including the DC-DC converter 100, according to an embodiment.

Referring to FIG. 15, the electronic device 1000 may include a power management integrated circuit (PMIC) 1100, a battery 1200, a power interface 1300, and one or more functional blocks 1400.

The battery 1200 may include one or more battery cells, and may be built-in into the electronic device 1000 or may be detachably attached to the electronic device 1000. When an external charging device is not connected to the electronic device 1000, the battery 1200 may supply power to the PMIC 1100.

The power interface 1300 may include a wired power interface for wired charging or a wireless power interface for wireless charging. The power interface 1300 may include a charging circuit, and for example, may include a rectifier, a regulator, etc.

For example, a travel adapter (TA) or an auxiliary battery may be electrically connected to the power interface 1300. The TA may convert power supplied from a household power source of AC 110 V to 220 V or another power supply means (for example, a computer) into DC power and provide the DC power to the battery 1200 or the PMIC 1100.

The PMIC 1100 may generate an output voltage Vout based on an input voltage Vin provided from the battery 1200 or provided through the power interface 1300, and may provide a power voltage based on the output voltage Vout to the one or more functional blocks 1400.

The PMIC 1100 may include the DC-DC converter 100 according to an embodiment. As described above, the DC-DC converter 100 may control the switching operation of the power conversion circuit 110 according to the on-time extension control method when the load current increases rapidly, and thus, an inductor current may increase rapidly. Thereafter, the DC-DC converter 100 may detect the point in time when the inductor current becomes equal to the load current using a differentiator, and when the inductor current becomes equal to the load current, terminates the on-time extension control operation and controls the switching operation of the power conversion circuit 110 according to the pulse modulation control method, thereby preventing the output voltage Vout from excessively increasing or decreasing. Accordingly, the reliability of the functional block 1400 that supplies a power voltage of the DC-DC converter 100 increases, and the performance of the functional block 1400 and the electronic device 1000 may be improved.

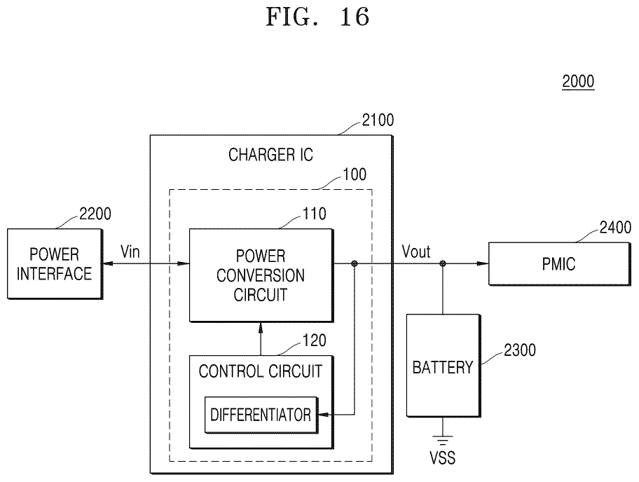

FIG. 16 is a block diagram schematically illustrating an electronic device 2000 including the DC-DC converter 100, according to an embodiment.

Referring to FIG. 16, the electronic device 2000 may include a charger integrated circuit (IC) 2100, a power interface 2200, a battery 2300, and a PMIC 2400.

The charger integrated circuit (IC) 2100 may charge the battery 2300 or supply power to the PMIC 2400 based on an input voltage Vin provided from an external device through the power interface 2200.

The charger integrated circuit (IC) 2100 may also supply power to an external device via the power interface 2200 connected to the charger integrated circuit 2100 based on a voltage charged to the battery 2300. For example, an On The Go (OTG) device (e.g., an OTG USB device, etc.) may be connected to the power interface 2200, and the charger integrated circuit 2100 can provide power to the OTG device via the power interface 2200.

The charger integrated circuit (IC) 2100 may include the DC-DC converter 100 according to an embodiment. The DC-DC converter 100 may control the switching operation of the power conversion circuit 110 according to the on-time extension control method when the load current increases rapidly, and may prevent the output voltage Vout from excessively increasing or decreasing by terminating the on-time extension control operation at the time when the inductor current becomes equal to the load current and controlling the switching operation of the power conversion circuit 110 according to the pulse modulation control method. Accordingly, the charging performance of the battery 2300 may be improved, and the performance and reliability of the PMIC 2400 may be improved.

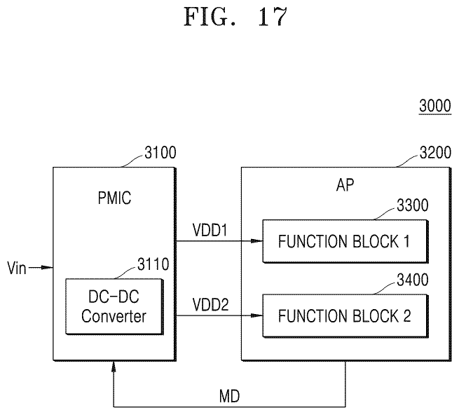

FIG. 17 is a block diagram schematically showing an electronic device 3000 including the DC-DC converter 100, according to an embodiment.

Referring to FIG. 17, the electronic device 3000 may include a PMIC 3100 and an application processor (AP) 3200.

The PMIC 3100 may generate a plurality of power supply voltages, for example, a first power supply voltage VDD1 and a second power supply voltage VDD2, based on an input voltage Vin, and may provide the first power supply voltage VDD1 and the second power supply voltage VDD2 to a plurality of functional blocks, for example, a first functional block 3300 and a second functional block 3400, respectively, provided in the AP 3200.

The PMIC 3100 may include one or more DC-DC converters 3110, and the one or more DC-DC converters 3110 may generate the first power supply voltage VDD1 and the second power supply voltage VDD2 based on an input voltage Vin.

The DC-DC converter 100 (refer to FIG. 1) according to an embodiment may be applied to the at least one of the one or more DC-DC converters 3110. The one or more DC-DC converters 3110 may perform an on-time extension control operation when the load current increases rapidly, and may terminate the on-time extension control operation at a time point when the inductor current becomes equal to the load current and perform a control operation according to a pulse modulation control method.

In an embodiment, the control circuit provided in the one or more DC-DC converters 3110 may include a threshold voltage detector 20 and a voltage slew detector 30c, as described with reference to FIG. 11, and the voltage slew detector 30c may generate a first differential information signal Sdiff1 and a second differential information signal Sdiff2.

The AP 3200 may set a mode of the one or more DC-DC converters 3110 and may provide a mode setting signal MD indicating the mode to the one or more DC-DC converters 3110. The one or more DC-DC converters 3110 may operate in a first mode, a second mode, and a third mode based on the mode setting signal MD. In the first mode, the one or more DC-DC converters 3110 may start an on-time extension control operation based on the threshold voltage detection signal Sdet, in the second mode, the one or more DC-DC converters 3110 may start an on-time extension control operation based on the second differential information signal Sdiff2, and in the third mode, the one or more DC-DC converters 3110 may start an on-time extension control operation based on the threshold voltage detection signal Sdet or the second differential information signal Sdiff2.

The AP 3200 may set a mode of the one or more DC-DC converters 3110 based on the transient response characteristics of the power supply voltage used by the first functional block 3300 and the second functional block 3400. For example, when there is a very fast transient response characteristic, the AP 3200 may set the one or more DC-DC converters 3110 to the second mode. For example, when the transient response characteristic is variable, the one or more DC-DC converters 3110 may be set to the third mode. However, embodiments are not limited thereto, and the AP 3200 may set the mode of the one or more DC-DC converters 3110 based on the transient response characteristic of the one or more DC-DC converters 3110 according to each mode and the transient response characteristic in the first functional block 3300 and the second functional block 3400. In some embodiments, the mode of the one or more DC-DC converters 3110 may be set in advance by being stored in a register provided in the PMIC 3100.

In the electronic device 3000 to which the PMIC 3100 including the one or more DC-DC converters 3110 according to an embodiment is applied, the transient response characteristics of the first power supply voltage VDD1 and the second power supply voltage VDD2 may be improved, and the first power supply voltage VDD1 and the second power supply voltage VDD2 may be prevented from excessively increasing or decreasing. Accordingly, the performances of the first functional block 3300, the second functional block 3400, and the AP 3200 may be improved.

According to an aspect of the present disclosure, there is provided a direct current to direct current (DC-DC) converter including a power conversion circuit comprising an inductor, and a plurality of power switches, and configured to generate an output voltage by stepping down an input voltage based on a switching operation of the plurality of power switches, an error amplifier configured to generate an error voltage between the output voltage and a first reference voltage, a threshold voltage detector configured to compare the output voltage with a threshold voltage and generate a threshold voltage detection signal having an on level if the output voltage is less than or equal to the threshold voltage, a voltage slew detector configured to generate a differential voltage by differentiating the output voltage and generate a first differential information signal based on the differential voltage, and a control circuit configured to control the power conversion circuit to repeat an on state and an off state based on the error voltage, control the power conversion circuit to maintain the on state in response to the threshold voltage detection signal of the on level, and control the power conversion circuit to terminate the maintaining of the on state if the differential value of the output voltage is 0.

In an embodiment, in the on state of the power conversion circuit, the inductor current flowing through the inductor may increase, and in the off state of the power conversion circuit, the inductor current may decrease.

In an embodiment, the voltage slew detector may generate a second differential information signal having an on level if the differential value of the output voltage is greater than a threshold value based on the differential voltage, and may generate the second differential information signal having an off level if the differential value is less than or equal to the threshold value.

In an embodiment, the control circuit may control the power conversion circuit to maintain the on state from an earlier point in time among the point in time when the threshold voltage detection signal transitions from the off level to the on level and the point in time when the second differential information signal transitions from the on level to the off level.

As described above, example embodiments have been described in the drawings and specification. In the present specification, the example embodiments are described by using some specific terms, but the terms used are for the purpose of describing the technical scope of the present disclosure only and are not intended to be limiting of meanings or the technical scope described in the claims. Therefore, it will be understood by those skilled in the art that various changes in form and details may be made therein without departing from the spirit and scope as defined by the appended claims. Accordingly, the scope of the present disclosure is defined not by the detailed description above but by the appended claims.

While various embodiments have been particularly shown and described with reference to the drawings, it will be understood that various changes in form and details may be made therein without departing from the spirit and scope of the following claims.

What is claimed is:

1. A direct current to direct current (DC-DC) converter comprising:
a power conversion circuit including a plurality of power switches, the power conversion circuit being configured to generate an output voltage by adjusting a level of an input voltage based on a switching operation of the plurality of power switches; and
a control circuit configured to generate a switching control signal for controlling the switching operation of the plurality of power switches,
wherein the control circuit comprises:
an error amplifier configured to generate an error voltage between a first reference voltage and a feedback voltage based on the output voltage;
a voltage slew detector configured to generate a differential voltage by differentiating the feedback voltage and to generate a first differential information signal based on the differential voltage; and
a pulse modulation logic that is configured to generate a first pulse modulation signal including a first on-time and a first off-time, based on the error voltage, and output the first pulse modulation signal as the switching control signal, and that is configured to generate a second pulse modulation signal including a second on-time that is greater than the first on-time of the first pulse modulation signal, and output the second pulse modulation signal as the switching control signal, and while the second pulse modulation signal is being output as the switching control signal, the pulse modulation logic is further configured to terminate generating the second pulse modulation signal based on a transition from an on level to an off level of the first differential information signal.

2. The DC-DC converter of claim 1, wherein the control circuit further includes a threshold voltage detector configured to compare the feedback voltage with a threshold voltage, output a threshold voltage detection signal having an off level when the feedback voltage is greater than the threshold voltage, and output the threshold voltage detection signal having an on level when the feedback voltage is less than or equal to the threshold voltage, and
wherein the control circuit is configured to generate the second pulse modulation signal based on a second transition from the off level to the on level of the threshold voltage detection signal.

3. The DC-DC converter of claim 1, wherein the voltage slew detector comprises:
a differentiator configured to differentiate the feedback voltage and generate the differential voltage based on a second reference voltage; and
a first comparator configured to compare the differential voltage with the second reference voltage, and generate the first differential information signal having the on level base on the differential voltage being greater than the second reference voltage, and generate the first differential information signal having the off level based on the differential voltage being less than or equal to the second reference voltage.

4. The DC-DC converter of claim 3, wherein the off level of the first differential information signal indicates that a differential value of the output voltage is 0.

5. The DC-DC converter of claim 3, wherein the voltage slew detector further includes:
a second comparator configured to compare the differential voltage with a third reference voltage, the third reference voltage being greater than the second reference voltage, generate a second differential information signal having an on level based on the differential voltage being greater than the third reference voltage, and generate the second differential information signal having an off level based on the differential voltage being less than or equal to the third reference voltage.

6. The DC-DC converter of claim 5, wherein the control circuit is configured to generate the second pulse modulation signal based on a transition from the off level to the on level of the second differential information signal.

7. The DC-DC converter of claim 5, wherein the control circuit is configured to generate the second pulse modulation signal at a point in time that is the earlier of a point in time at which the feedback voltage drops below a threshold voltage and a point in time at which the second differential information signal transitions from the off level to the on level.

8. The DC-DC converter of claim 1, wherein the power conversion circuit further includes an inductor connected to the plurality of power switches, and
wherein the first on-time of the first pulse modulation signal and the second on-time of the second pulse modulation signal correspond to a period during which current flowing in the inductor increases.

9. The DC-DC converter of claim 1, wherein the power conversion circuit is configured to generate the output voltage by stepping down the input voltage, and
the second pulse modulation signal includes the second on-time and does not include a second off-time.

10. The DC-DC converter of claim 1, wherein the second pulse modulation signal includes the second on-time and a second off-time, and
wherein the second on-time and the second off-time are preset.

11. A direct current to direct current (DC-DC) converter comprising:
a power conversion circuit comprising an inductor, a first power switch, and a second power switch, the power conversion circuit being configured to generate an output voltage by stepping down a level of an input voltage based on a switching operation of the first power switch and the second power switch; and
a control circuit configured to:
control the power conversion circuit to repeat an on state and an off state at a switching frequency based on an error voltage between the output voltage and a reference voltage, and an inductor current flowing through the inductor increasing during the on state and decreasing during the off state,
control the power conversion circuit to maintain the on state based on the output voltage decreasing below a threshold voltage, or a rate of change of the output voltage exceeding a threshold value, and
control the power conversion circuit to terminate the maintaining of the on state when a derivative of the output voltage is 0.

12. The DC-DC converter of claim 11, wherein the control circuit comprises:
an error amplifier configured to receive the output voltage and the reference voltage and generate the error voltage; and
a voltage slew detector configured to differentiate the output voltage to generate a differential voltage, and generate a first differential information signal indicating that a differential value of the output voltage is 0 based on the differential voltage.

13. The DC-DC converter of claim 12, wherein the control circuit further comprises a threshold voltage detector configured to output a threshold voltage detection signal having an off level when the output voltage is greater than the threshold voltage, and output the threshold voltage detection signal having an on level when the output voltage is less than or equal to the threshold voltage, and
wherein the control circuit controls the power conversion circuit to maintain the on state based on a transition from the off level to the on level of the threshold voltage detection signal.

14. The DC-DC converter of claim 13, wherein the voltage slew detector is configured to generate a second differential information signal having an on level based on the differential value of the output voltage being greater than the threshold value, and generate the second differential information signal having an off level based on the differential value being less than or equal to the threshold value, based on the differential voltage, and
wherein the control circuit is configured to control the power conversion circuit to maintain the on state based on a transition from the on level to the off level of the second differential information signal.

15. The DC-DC converter of claim 14, wherein the control circuit is configured to control the power conversion circuit to maintain the on state from a point in time that is the earlier of a first point in time at which the threshold voltage detection signal transitions from the off level to the on level and a second point in time at which the second differential information signal transitions from the on level to the off level.

16. A method of operating a direct current to direct current (DC-DC) converter comprising a power conversion circuit configured to generate an output voltage from an input voltage based on a switching operation of a plurality of power switches; and a control circuit configured to generate a plurality of switching control voltages provided to the plurality of power switches,
the method comprising:
generating, by the control circuit, a first pulse modulation signal based on an error voltage between a feedback voltage based on the output voltage and a reference voltage;
generating, by the control circuit, the plurality of switching control voltages based on the first pulse modulation signal;
generating, by the control circuit, a second pulse modulation signal including a second on-time greater than a first on-time of the first pulse modulation signal;
generating, by the control circuit, the plurality of switching control voltages based on the second pulse modulation signal; and
terminating, by the control circuit, the generating the second pulse modulation signal based on a differential value of the output voltage being 0.

17. The method of claim 16, wherein the second pulse modulation signal is generated based on the output voltage being less than or equal to a threshold voltage.

18. The method of claim 16, wherein the second pulse modulation signal is generated based on the differential value of the output voltage being greater than a threshold value.

19. The method of claim 16, wherein a current flowing through an inductor of the power conversion circuit increases during the first on-time of the first pulse modulation signal and the second on-time of the second pulse modulation signal.

20. The method of claim 16, wherein
the power conversion circuit generates the output voltage by stepping down the input voltage, and
the second pulse modulation signal includes the second on-time but does not include an off-time.
